(19) United States
(12) Patent Application Publication
(10) Pub. No.: US 2014/0152408 A1
(43) Pub. Date: Jun. 5, 2014

(54) RARE-EARTH PERMANENT MAGNET AND METHOD FOR MANUFACTURING RARE-EARTH PERMANENT MAGNET

(71) Applicant: NITTO DENKO CORPORATION, Ibaraki-shi, Osaka (JP)

(72) Inventors: Tomohiro Omure, Ibaraki-shi (JP); Katsuya kume, Ibaraki-shi (JP); Toshiaki Okuno, Ibaraki-shi (JP); Izumi Ozeki, Ibaraki-shi (JP); Takashi Ozaki, Ibaraki-shi (JP); Keisuke Taihaku, Ibaraki-shi (JP); Takashi Yamamoto, Ibaraki-shi (JP)

(73) Assignee: NITTO DENKO CORPORATION

(21) Appl. No.: 14/234,538

(22) PCT Filed: Mar. 8, 2013
(86) PCT No.: PCT/JP2013/056432

§ 371 Date: Jan. 23, 2014

(30) Foreign Application Priority Data
Mar. 12, 2012 (JP) 2012-054699

(51) Int. Cl. H01F 41/02; H01F 7/02

(52) U.S. Cl. CPC H01F 41/0266; H01F 7/021
USPC 335/302; 419/33

(57) ABSTRACT

There are provided a rare-earth permanent magnet and a manufacturing method of a rare-earth permanent magnet capable of improving magnetic properties with drastically enhanced manufacturing efficiency. In the method, magnet material is milled into magnet powder. Next, the magnet powder and a binder are mixed to obtain a mixture 12. Next, the thus prepared mixture 12 is formed into a long-sheet-like shape on a supporting base 13 by hot-melt molding so as to obtain a green sheet 14. The thus formed green sheet 14 is heated to soften and a magnetic field is applied to multiple layers of the heated green sheet 14 for magnetic field orientation. The green sheet 14 subjected to the magnetic field orientation is sintered and thereby a permanent magnet 1 is obtained.

### TECHNICAL FIELD

The present invention relates to a rare-earth permanent magnet and a method for manufacturing the rare-earth permanent magnet.

### BACKGROUND ART

In recent years, a decrease in size and weight, an increase in power output and an increase in efficiency have been required in a permanent magnet motor used in a hybrid car, a hard disk drive, or the like. To realize such a decrease in size and weight, an increase in power output and an increase in efficiency in the permanent magnet motor mentioned above, film-thinning and a further improvement in magnetic performance have been required of a permanent magnet to be embedded in the permanent magnet motor.

Here, as a method for manufacturing the permanent magnet used in the permanent magnet motor, a powder sintering method is generally used. In the powder sintering method, a raw material is first pulverized with a jet mill (dry-milling) to produce a magnet powder. Thereafter, the magnet powder is placed in a mold, and press-molded to a desired shape. Then, the solid magnet powder molded into the desired shape is sintered at a predetermined temperature (for example, 1100 degrees Celsius in a case of an Nd—Fe—B-based magnet), thereby manufacturing the permanent magnet (for instance, Japanese Laid-open Patent Application Publication No. 2-266503). Further, for the purpose of improving the magnetic properties of a permanent magnet, magnetic field orientation is commonly performed by applying a magnetic field from outside. In the conventional powder sintering method for a permanent magnet, at press molding, magnet powder is put in a mold, exposed to a magnetic field for magnetic field orientation, and then pressurized, so that a compact body is formed. Further, in other manufacturing methods for a permanent magnet such as extrusion molding, injection molding, a roll forming method and the like, the magnet is formed through pressurization in an atmosphere under a magnetic field. Thereby, it becomes possible to obtain a formed body of the magnet powder having an easy axis of magnetization aligned in the application direction of the magnetic field.

### PRIOR ART DOCUMENT

### Patent Document

Patent document 1: Japanese Laid-open Patent Application Publication No. 2-266503 (page 5)

### DISCLOSURE OF THE INVENTION

### Problem to be Solved by the Invention

However, when the permanent magnet is manufactured through the above-mentioned powder sintering method, there have been problems as follows. In the powder sintering method, it is necessary to secure a predetermined porosity in a press-molded magnet powder in order to perform magnetic field orientation. The magnet powder having the predetermined porosity is, however, difficult to uniformly contract at the time of sintering. Accordingly deformation such as warpage and depressions occurs after sintering. Further, since pressure unevenness occurs at the time of pressing the magnet powder, the magnet is formed to have inhomogeneous density after sintering to generate distortion on a surface of the magnet. Conventionally, it has therefore been required to compression-mold the magnet powder to a larger size than that of a desired shape, assuming that the surface of the magnet has some distortion. Then, diamond cutting and polishing operations have been performed after sintering, for alteration to the desired shape. As a result, the number of manufacturing processes increases, and there also is a possibility of deteriorating qualities of the permanent magnet manufactured.

Specifically, when a thin-film magnet is cut out of a bulk body having a larger size as discussed above, material yield is significantly decreased. Further, a problem of large increase in man-hours has also been raised.

The present invention has been made in order to solve the above-mentioned conventional problems, and an object of the invention is to provide a rare-earth permanent magnet and a manufacturing method of the rare-earth permanent magnet wherein deformation such as warpage and depressions is suppressed in a sintered magnet through the steps of mixing a binder to magnet powder and forming into a green sheet and applying a magnetic field to multiple layers of stacked green sheet and the magnetic field orientation can be optimized while drastically enhancing manufacturing efficiency and improving the magnetic properties of the permanent magnet.

### Means for Solving the Problem

To achieve the above object, the present invention provides a manufacturing method of a rare-earth permanent magnet comprising steps of: milling magnet material into magnet powder; preparing a mixture of the magnet powder and a binder; obtaining a green sheet through thermally melting and forming the mixture into a sheet-like shape; heating the green sheet and simultaneously/subsequently applying a magnetic field to multiple layers of the heated green sheet, for magnetic field orientation; and sintering the green sheet subjected to the magnetic field orientation.

In the above-described manufacturing method of a rare-earth permanent magnet of the present invention, in the step of heating the green sheet and simultaneously/subsequently applying a magnetic field, multiple layers of the green sheet are heated.

In the above-described manufacturing method of a rare-earth permanent magnet of the present invention, in the step of obtaining a green sheet, a base that is continuously conveyed is coated with the mixture, so as to form the green sheet on the base, and in the step of heating the green sheet and simultaneously/subsequently applying a magnetic field, the green sheet is continuously conveyed together with the base.

The above-described manufacturing method of a rare-earth permanent magnet of the present invention further comprises steps of: after the step of obtaining a green sheet, rolling up the green sheet around each of a plurality of first rolls, and drawing out the green sheet from each of the plurality of first rolls, and stacking up the drawn-out green sheet to form the multiple layers of the green sheet, so that the magnetic field is simultaneously applied to the multiple layers of the green sheet; and separating the multiple layers of the green sheet subjected to the magnetic field orientation back into each single layer of the green sheet, and rolling up the single layer of the green sheet around each of a plurality of second rolls.

In the above-described manufacturing method of a rare-earth permanent magnet of the present invention, in the step of obtaining a green sheet, each of a plurality of bases drawn out from a plurality of third rolls is coated with the mixture, so as to form the green sheet on each of the plurality of bases, and in the step of heating the green sheet and simultaneously/subsequently applying a magnetic field, the green sheet on each of the plurality of bases is stacked to form multiple layers of the green sheet and the magnetic field is simultaneously applied to the multiple layers of the green sheet, and the manufacturing method further comprises a step of: separating the multiple layers of the green sheet subjected to the magnetic field orientation back into each single layer of the green sheet, and rolling up the single layer of the green sheet around each of a plurality of fourth rolls.

In the above-described manufacturing method of a rare-earth permanent magnet of the present invention, in the step of heating the green sheet and simultaneously/subsequently applying a magnetic field, the green sheet conveyed together with the base is made to pass through a solenoid charged with electric current.

In the above-described manufacturing method of a rare-earth permanent magnet of the present invention, the binder is any one of thermoplastic resin, a long-chain hydrocarbon and a fatty acid methyl ester, or any mixture thereof, and in the step of heating the green sheet and simultaneously/subsequently applying a magnetic field, the green sheet is heated to a temperature equal to or higher than a glass-transition point or melting point of the binder.

In the above-described manufacturing method of a rare-earth permanent magnet of the present invention, before the step of sintering the green sheet, the binder is decomposed and removed from the green sheet by holding the green sheet for a predetermined length of time at binder decomposition temperature in a non-oxidizing atmosphere.

To achieve the above object, the present invention provides a rare-earth permanent magnet manufactured through steps of: milling magnet material into magnet powder; preparing a mixture of the magnet powder and a binder; obtaining a green sheet through thermally melting and forming the mixture into a sheet-like shape; heating the green sheet and simultaneously/subsequently applying a magnetic field to multiple layers of the heated green sheet, for magnetic field orientation; and sintering the green sheet subjected to the magnetic field orientation.

### Effect of the Invention

According to the manufacturing method of a rare-earth permanent magnet of the present invention, the permanent magnet manufactured is a sintered magnet made from a green sheet obtained by mixing magnet powder and a binder and thermally melting and forming the mixture into a sheet-like shape. Therefore, the thus sintered green sheet uniformly contracts so that deformations such as warpage and depressions do not occur in the sintered green sheet, and pressure can be uniformly applied thereto at pressurizing. Accordingly, no adjustment process is necessitated which has been conventionally performed after sintering, and manufacturing process can be simplified. Thereby, a permanent magnet can be manufactured with dimensional accuracy. Further, even if such permanent magnets are made thin in the course of manufacturing, increase in the number of manufacturing processes can be avoided without lowering a material yield.

Further, the green sheet produced through thermally melting and forming is heated and magnetic field orientation is performed by applying a magnetic field to the green sheet thus formed. Accordingly, optimized magnetic field orientation can be performed even after forming the green sheet, and improvement of the magnetic properties of the permanent magnet is achieved. Further, there is no concern of imbalanced liquid distribution, namely, problematic unevenness in thickness of the green sheet when the magnetic field is applied. Further, the green sheet is conveyed into a homogeneous magnetic field and heated therein so that the viscosity of the binder decreases, and accordingly, uniform c-axis orientation can be achieved just by a rotary torque in the homogeneous magnetic field. The binder therein is well intermingled, so that no delamination occurs at a process of removing the binder.

Further, the green sheet is stacked in multiple layers when the magnetic field is applied to the green sheet, so that multiple layers of green sheet can be simultaneously oriented in the c-axis direction in a single process and the manufacturing efficiency can be drastically enhanced. Further, even when stacked, the green sheet produced through thermally melting and forming is less likely to cause defects such as deformation, in comparison with the green sheet formed from slurry, so that the green sheet can be securely stacked in multiple layers.

Further, in the manufacturing method of the rare-earth permanent magnet according to the present invention, the green sheet is heated under a state stacked in multiple layers. Accordingly, plural pieces of green sheet can be simultaneously heated in a single process, so that the manufacturing efficiency can be drastically enhanced.

Further, according to the manufacturing method of a rare-earth permanent magnet of the present invention, the green sheet is formed by coating a continuously-conveyed base with the mixture, and heat and magnetic field are applied to the green sheet that is continuously conveyed together with the base. Accordingly, continuous process can be exercised from the step of forming the green sheet to the step of heating the green sheet and magnetic field orientation. Thereby, the manufacturing process can be simplified and productivity can be improved.

Further, in the manufacturing method of the rare-earth permanent the magnet according to the present invention, the green sheet produced through thermally melting and forming is rolled around a first roll, and the green sheet is drawn out from each of a plurality of first rolls and stacked to form multiple layers of the green sheet, and the magnetic field is simultaneously applied to the multiple layers of the green sheet. Thereafter, the multiple layers of the green sheet subjected to the magnetic field orientation are separated back into each single layer and rolled around each of a plurality of second rolls. Accordingly, processes from stacking the layers of the green sheet to heating and magnetic field orientation can be integrated, so that simplified manufacturing processes and improved productivity can be achieved.

Further, in the manufacturing method of the rare-earth permanent magnet according to the present invention, the mixture coats each of a plurality of bases drawn out from a plurality of third rolls and is formed in a sheet-like shape, so that the green sheet is produced on each base, and the green sheet on each base is stacked to form multiple layers of the green sheet. The magnetic field is simultaneously applied to the multiple layers of the green sheet, and thereafter the multiple layers of the green sheet subjected to the magnetic field orientation are separated back into each single layer and rolled around each of a plurality of fourth rolls. Accordingly, processes from stacking layers of the green sheet to heating and magnetic field orientation can be integrated so that a simplified manufacture and improved productivity can be achieved.

Further, according to the manufacturing method of a rare-earth permanent magnet of the present invention, the green sheet conveyed together with the base is made to pass through a solenoid charged with electric current so as to apply magnetic field to the green sheet for magnetic field orientation. Accordingly, homogeneous magnetic field can be applied to the green sheet and homogeneous and optimized magnetic field orientation can be performed.

Further, according to the manufacturing method of a rare-earth permanent magnet of the present invention, the green sheet is heated to a temperature equal to or higher than a glass-transition point or melting point of the binder to soften for the magnetic field orientation, so that the optimal magnetic field orientation can be performed.

Further, according to the manufacturing method of a rare-earth permanent magnet of the present invention, before the step of sintering the green sheet, the binder is decomposed and removed from the green sheet by holding the green sheet for a predetermined length of time at binder decomposition temperature in a non-oxidizing atmosphere. Thereby, carbon content in the magnet can be reduced previously. Consequently, the entirety of the magnet can be sintered densely without making a gap between a main phase and a grain boundary phase in the sintered magnet and decline of coercive force can be avoided. Further, alpha iron does not separate out in large amounts in the main phase of the sintered magnet and serious deterioration of magnetic properties can be avoided.

According to the rare-earth permanent magnet of the present invention, the permanent magnet manufactured is a sintered magnet made from a green sheet obtained by mixing magnet powder and a binder and thermally melting and forming the mixture into a sheet-like shape. The thus sintered green sheet uniformly contracts and deformation such as warpage and depressions does not occur there. Further, there is eliminated uneven pressurization at pressing, which makes an adjustment process to be conventionally performed after sintering and simplifies the manufacturing process. Thereby, a permanent magnet can be manufactured with dimensional accuracy. Further, even if such permanent magnets are made thin in the course of manufacturing, increase in the number of manufacturing processes can be avoided without lowering a material yield.

Further, the green sheet produced through thermally melting and forming is heated and magnetic field orientation is performed by applying a magnetic field to the green sheet thus formed. Accordingly, optimized magnetic field orientation can be performed even after forming the green sheet, and improvement of the magnetic properties of the permanent magnet is achieved. Further, there is no concern of imbalanced liquid distribution, namely, problematic unevenness in thickness of the green sheet when the magnetic field is applied. Further, the green sheet is conveyed into a homogeneous magnetic field and heated therein so that the viscosity of the binder decreases, and accordingly, uniform c-axis orientation can be achieved just by a rotary torque in the homogeneous magnetic field. Further, the binder therein is well intermingled, so that no delamination occurs at a process of removing the binder.

Further, the green sheet is stacked in multiple layers when the magnetic field is applied to the green sheet, so that multiple layers of green sheet can be simultaneously oriented in c-axis direction in a single process and the manufacturing efficiency can be drastically enhanced. Further, even when stacked, the green sheet produced through thermally melting and forming is less likely to cause deformation, etc., in comparison with the green sheet formed from slurry, so that the green sheet can be securely stacked in multiple layers.

### BRIEF DESCRIPTION OF THE DRAWINGS

FIG. 1 is an overall view of a permanent magnet according to the invention.

FIG. 2 is an explanatory diagram illustrating a manufacturing process of a permanent magnet according to the invention.

FIG. 3 is an explanatory diagram specifically illustrating a formation process of the green sheet in the manufacturing process of the permanent magnet according to the invention.

FIG. 4 is an explanatory diagram specifically illustrating a stacking process, a heating process and a magnetic field orientation process of the green sheet in the manufacturing process of the permanent magnet according to the invention.

FIG. 5 is a diagram illustrating an example of the magnetic field orientation in a direction perpendicular to a plane of the green sheet.

FIG. 6 is an explanatory diagram illustrating a heating device using a heat carrier (silicone oil).

FIG. 7 is an explanatory diagram specifically illustrating a pressure sintering process of the green sheet in the manufacturing process of the permanent magnet according to the invention.

FIG. 8 is a view depicting an external appearance of a green sheet according to an embodiment.

FIG. 9 is a scanning electron microscope (SEM) image of the green sheet according to the embodiment in close-up.

FIG. 10 is an inverse pole figure showing crystal orientation distribution in the green sheet according to the embodiment.

FIG. 11 is a table illustrating various measurement results of magnets according to embodiments and comparative examples, respectively.

### BEST MODE FOR CARRYING OUT THE INVENTION

A specific embodiment of a rare-earth permanent magnet and a method for manufacturing the rare-earth permanent magnet according to the present invention will be described below in detail with reference to the drawings.

[Constitution of Permanent Magnet]

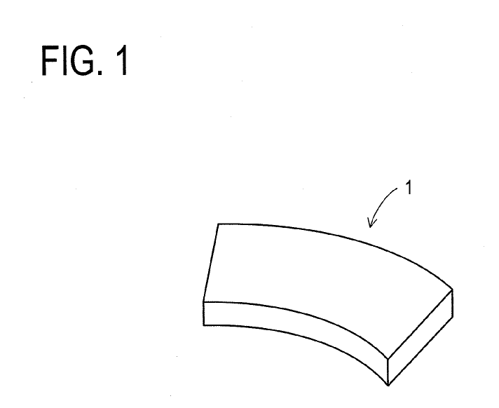

First, a constitution of a permanent magnet 1 according to the present invention will be described. FIG. 1 is an overall view of the permanent magnet 1 according to the present invention. Incidentally, the permanent magnet 1 depicted in FIG. 1 has a fan-like shape; however, the shape of the permanent magnet 1 can be changed according to the shape of a cutting-die.

As the permanent magnet 1 according to the present invention, an Nd—Fe—B-based anisotropic magnet may be used. Incidentally, the contents of respective components are regarded as Nd: 27 to 40 wt %, B: 0.8 to 2 wt %, and Fe (electrolytic iron): 60 to 70 wt %. Furthermore, the permanent magnet 1 may include other elements such as Dy, Tb, Co, Cu, Al, Si, Ga, Nb, V, Pr, Mo, Zr, Ta, Ti, W, Ag, Bi, Zn or Mg in small amount, in order to improve the magnetic properties thereof. FIG. 1 is an overall view of the permanent magnet 1 according to the present embodiment.

The permanent magnet 1 as used herein is a thin film-like permanent magnet having a thickness of 0.05 to 10 mm (for instance, 1 mm), and is prepared by sintering a formed body (a green sheet) obtained by forming a mixture (a powdery mixture) of magnet powder and a binder into a sheet-like shape, as described later.

In the present invention, a resin, a long-chain hydrocarbon, a fatty acid methyl ester or a mixture thereof is used as the binder to be mixed with the magnet powder.

Further, if a resin is used as the binder, the resin used is preferably polymers having no oxygen atoms in the structure and being depolymerizable. Meanwhile, in the case where later-described hot-melt molding is employed for producing the green sheet, a thermoplastic resin is preferably used for the convenience of performing magnetic field orientation using the produced green sheet in a heated and softened state. Specifically, an optimal polymer is a polymer or a copolymer of one or more kinds of monomers selected from monomers expressed with the following general formula (I):

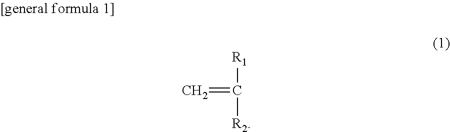

(wherein R₁ and R₂ each represent a hydrogen atom, a lower alkyl group, a phenyl group or a vinyl group).

Polymers that satisfy the above condition include: polyisobutylene (PIB) formed from isobutene polymerization, polyisoprene (isoprene rubber or IR) formed from isoprene polymerization, polybutadiene (butadiene rubber or BR) formed from butadiene polymerization, polystyrene formed from styrene polymerization, styrene-isoprene block copolymer (SIS) formed from copolymerization of styrene and isoprene, butyl rubber (IIR) formed from copolymerization of isobutylene and isoprene, styrene-butadiene block copolymer (SBS) formed from copolymerization of styrene and butadiene, Poly(2-methyl-1-pentene) formed from polymerization of 2-methyl-1-pentene, poly(2-methyl-1-butene) formed from polymerization of 2-methyl-1-butene, and poly(alpha-methylstyrene) formed from polymerization of alpha-methylstyrene. Incidentally, low molecular weight polyisobutylene is preferably added to the poly(alpha-methylstyrene) to produce flexibility. Further, resins to be used for the binder may include small amount of polymer or copolymer of monomers containing oxygen atoms (such as polybutylmethacrylate or polymethylmethacrylate). Further, monomers not satisfying the above general formula (I) may be partially copolymerized. Even in such a case, the purpose of this invention can be realized.

Incidentally, the binder is preferably made of a thermoplastic resin that softens at 250 degrees Celsius or lower, or specifically, a thermoplastic resin whose glass transition point or melting point is 250 degrees Celsius or lower.

Meanwhile, in a case a long-chain hydrocarbon is used for the binder, there is preferably used a long-chain saturated hydrocarbon (long-chain alkane) being solid at room temperature and being liquid at a temperature higher than the room temperature. Specifically, a long-chain saturated hydrocarbon having 18 or more carbon atoms is preferably used. In the case of employing the later-described hot-melt molding for forming the green sheet, the magnetic field orientation of the green sheet is performed under a state where the green sheet is heated and softened at a temperature higher than the melting point of the long-chain hydrocarbon.

In a case where a fatty acid methyl ester is used for the binder, there are preferably used methyl stearate, methyl docosanoate, etc., being solid at room temperature and being liquid at a temperature higher than the room temperature, similar to long-chain saturated hydrocarbon. In the case of using the later-described hot-melt molding when forming the green sheet, the magnetic field orientation of the green sheet is performed under a state where the green sheet is heated to be softened at a temperature higher than the melting point of fatty acid methyl ester.

Through using a binder that satisfies the above condition as binder to be mixed with the magnet powder when preparing the green sheet, the carbon content and oxygen content in the magnet can be reduced. Specifically, the carbon content remaining after sintering is made 2000 ppm or lower, or more preferably, 1000 ppm or lower. Further, the oxygen content remaining after sintering is made 5000 ppm or lower, or more preferably, 2000 ppm or lower.

Further, the amount of the binder to be added is an optimal amount to fill the gaps between magnet particles so that thickness accuracy of the sheet can be improved when forming the heated and molten mixture into a sheet-like shape. For instance, the binder proportion to the amount of magnet powder and binder in total in the slurry after the addition of the binder is preferably 1 wt % through 40 wt %, more preferably 2 wt % through 30 wt %, still more preferably 3 wt % through 20 wt %.

[Method for Manufacturing Permanent Magnet]

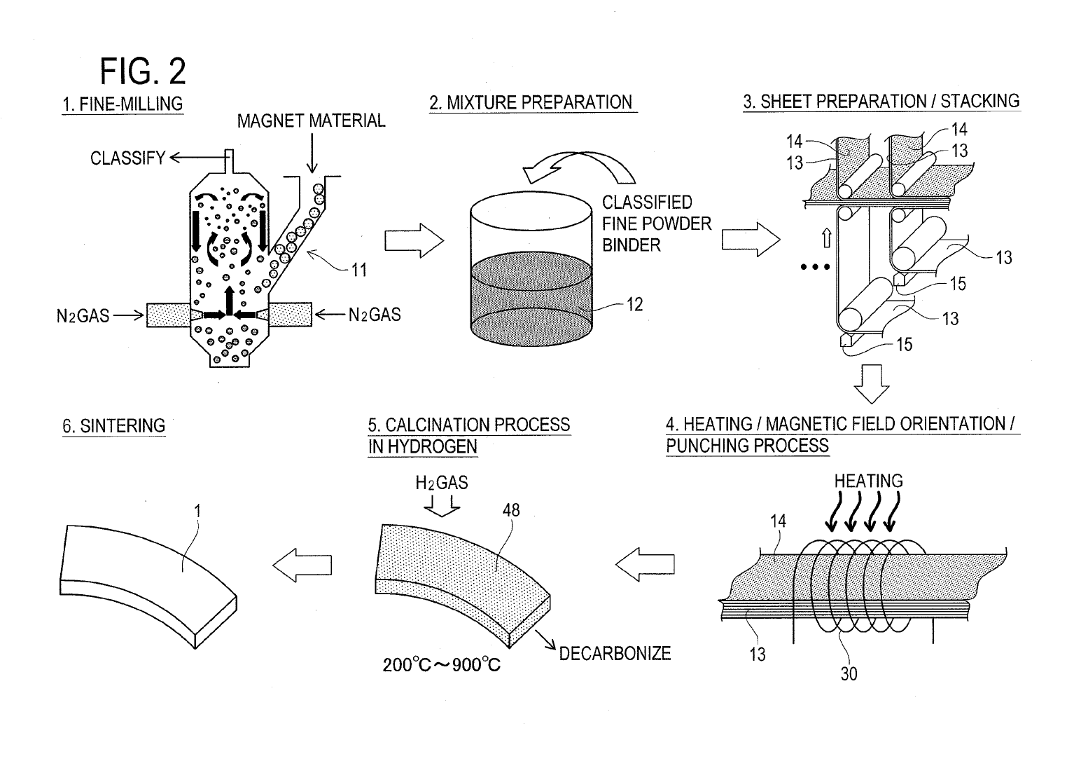

Next, a method for manufacturing the permanent magnet 1 according to the present invention will be described below with reference to FIG. 2. FIG. 2 is an explanatory view illustrating a manufacturing process of the permanent magnet 1 according to the present invention.

First, there is manufactured an ingot comprising Nd—Fe—B of certain fractions (for instance, Nd: 32.7 wt %, Fe (electrolytic iron): 65.96 wt %, and B: 1.34 wt %). Thereafter the ingot is coarsely milled using a stamp mill, a crusher, etc. to a size of approximately 200 μm. Otherwise, the ingot is melted, formed into flakes using a strip-casting method, and then coarsely milled using a hydrogen pulverization method.

Next, the coarsely milled magnet powder is finely milled with a jet mill 11 to form fine powder of which the average particle diameter is smaller than a predetermined size (for instance, 1.0 μm through 5.0 μm) in: (a) an atmosphere composed of inert gas such as nitrogen gas, argon (Ar) gas, helium (He) gas or the like having an oxygen content of substantially 0%; or (b) an atmosphere composed of inert gas such as nitrogen gas, Ar gas, He gas or the like having an oxygen content of 0.0001 through 0.5%. Here, the term “having an oxygen content of substantially 0%” is not limited to a case where the oxygen content is completely 0%, but may include a case where oxygen is contained in such an amount as to allow a slight formation of an oxide film on the surface of the fine powder. Incidentally, wet-milling may be employed for a method for milling the magnet material. For instance, in a wet method by a bead mill, using toluene as a solvent, coarsely milled magnet powder may be finely milled to a predetermined size (for instance, 0.1 μm through 5.0 μm). Thereafter, the magnet powder included in the organic solvent after the wet milling may be dried by such a method as vacuum desiccation to obtain the desiccated magnet powder. Otherwise, the binder may be added to the organic solvent after the wet milling and kneaded, without removing the magnet powder from the organic solvent, and then the organic solvent may be volatilized, so as to obtain the later described mixture 12.

Through employing the above wet-milling, the magnetic material can be milled into still smaller grain sizes than those in the dry-milling. However, if the wet-milling is employed, there rises a problem of residual organic compounds in the magnet due to the organic solvent, even if the later vacuum desiccation volatilizes the organic solvent. However, this problem can be solved by removing carbons from the magnet through performing the later-described calcination process to decompose the organic compounds remaining with the binder by heat.

Meanwhile, a binder is added to the magnet powder finely milled by the jet mill 11 or the like, to prepare a powdery mixture (a mixture) 12 of the magnet powder and the binder. Here, as mentioned above, there can be used a resin, a long-chain hydrocarbon, a fatty acid methyl ester as binder. For instance, when a resin is employed, it is preferable that the resin is made of a polymer or copolymer of monomers containing no oxygen atoms, and when a long-chain hydrocarbon is employed, it is preferable that a long-chain saturated hydrocarbon (long-chain alkane) is used. In a case where a fatty acid methyl ester is used for the binder, there are preferably used methyl stearate, methyl docosanoate, etc. Here, as mentioned above, the amount of binder to be added is preferably such that binder proportion to the amount of the magnet powder and the binder in total in the mixture 12 after the addition is within a range of 1 wt % through 40 wt %, more preferably 2 wt % through 30 wt %, or still more preferably 3 wt % through 20 wt %. Here, the addition of the binder is performed in an atmosphere composed of inert gas such as nitrogen gas, Ar gas or He gas. Here, at mixing the magnet powder and the binder together, the magnet powder and the binder are, for instance, respectively put into an organic solvent and stirred with a stirrer. After stirring, the organic solvent containing the magnet powder and the binder is heated to volatilize the organic solvent, so that the mixture 12 is extracted. It is preferable that the binder and the magnet powder is mixed under an atmosphere composed of inert gas such as nitrogen gas, Ar gas, He gas or the like. Further, specifically when the magnet powder is milled by a wet method, the binder may be added to an organic solvent used for the milling and kneaded, and thereafter the organic solvent is volatilized to obtain the mixture 12, without isolating the magnet powder out of the organic solvent used for the milling.

Subsequently, hot melt molding is performed in which the mixture 12 is heated to melt, and turned into a fluid state and then coats the supporting base 13 such as a separator. Thereafter, the mixture 12 coating the supporting base 13 is left to cool and solidify, so that the green sheet 14 can be formed in a long sheet fashion on the supporting base 13. Incidentally, the appropriate temperature for thermally melting the mixture 12 differs depending on the kind or amount of binder to be used, but is set here within a range of 50 through 300 degrees Celsius. However, the temperature needs to be higher than the melting point of the binder to be used.

Incidentally, the coating method of the molten mixture 12 is preferably a method excellent in layer thickness controllability, such as a slot-die system and a calender roll system. For instance, in the slot-die system, the mixture 12 heated to melt into a fluid state is extruded by a gear pump to put into the die, and then coating is performed. In the calender roll system, a predetermined amount of the mixture 12 is enclosed in a gap between two heated rolls, and the supporting base 13 is coated with the mixture 12 melted by the heat of the rolls, while the rolls are rotated. As supporting base 13, a silicone-treated polyester film is used, for instance. Further, a defoaming agent or a heat and vacuum defoaming method may preferably be employed in conjunction therewith, to sufficiently perform defoaming treatment so that no air bubbles remain in a layer of coating. Further, instead of coating the supporting base 13, extrusion molding may be employed that molds the molten mixture 12 into a sheet and extrudes the sheet-like mixture 12 onto the supporting base 13, so that a green sheet 14 is formed on the supporting base 13.

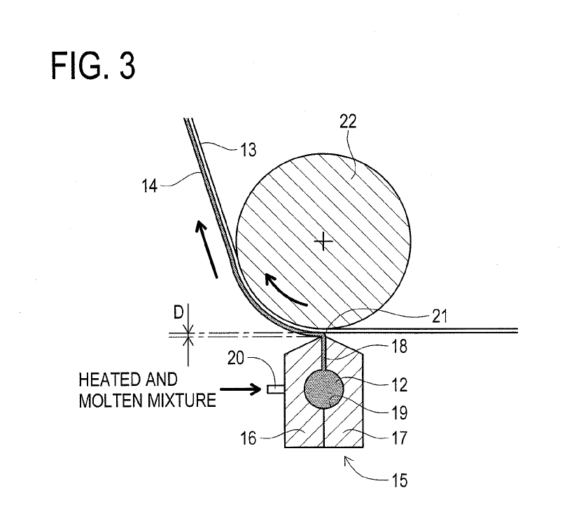

Here will be given a detailed description of the formation process of a green sheet 14 employing a slot-die system referring to FIG. 3. FIG. 3 is an explanatory diagram illustrating the formation process of the green sheet 14 employing the slot-die system.

As illustrated in FIG. 3, a slot die 15 used for the slot-die system is formed by putting blocks 16 and 17 together. There, a gap between the blocks 16 and 17 serves as a slit 18 and a cavity (liquid pool) 19. The cavity 19 communicates with a die inlet 20 formed in the block 17. Further, the die inlet 20 is connected to a coating fluid feed system configured with the gear pump and the like (not shown), and the cavity 19 receives the feed of metered fluid-state mixture 12 through the die inlet 20 by a metering pump and the like (not shown). Further, the fluid-state mixture 12 fed to the cavity 19 is delivered to the slit 18, and discharged at a predetermined coating width from a discharge outlet 21 of the slit 18, with pressure which is uniform in transverse direction in a constant amount per unit of time. Meanwhile, the supporting base 13 is conveyed along the rotation of a coating roll 22 at a predetermined speed. As a result, the discharged fluid-state mixture 12 is laid down on the supporting base 13 with a predetermined thickness. Thereafter, the mixture 12 is left to cool and solidify, so that a long-sheet-like green sheet 14 is formed on the supporting base 13.

Further, in the formation process of the green sheet 14 by the slot-die system, it is desirable to measure the actual sheet thickness of the green sheet 14 after coating, and to perform feed back control of a gap D between the slot die 15 and the supporting base 13 based on the measured thickness. Further, it is desirable to minimize the variation in feed rate of the fluid-state mixture 12 supplied to the slot die 15 (for instance, to suppress the variation within plus or minus 0.1%), and in addition, to also minimize the variation in coating speed (for instance, suppress the variation within plus or minus 0.1%). As a result, thickness precision of the green sheet 14 can further be improved. Incidentally, the thickness precision of the formed green sheet is within a margin of error of plus or minus 10% with reference to a designed value (for instance, 1 mm), preferably within plus or minus 3%, or more preferably within plus or minus 1%. Alternatively, in the calender roll system, the film thickness of the transferred mixture 12 on the supporting base 13 can be controlled through controlling a calendering condition according to an actual measurement value.

Incidentally, a preset thickness of the green sheet 14 is desirably within a range of 0.05 mm through 20 mm. If the thickness is set to be thinner than 0.05 mm, it becomes necessary to laminate many layers, which lowers the productivity.

Next, there are stacked multiple layers (for instance, six layers) of green sheet 14 formed on the supporting base 13 by the above-mentioned hot-melt molding. The stacking of layers of green sheet 14 may be performed subsequent to the hot-melt molding onto the supporting base 13. Instead, the green sheet 14 obtained by the hot-melt molding may be rolled around a roll (such as a first roll), and a plurality of rolls of the green sheet 14 are prepared. Later, plural pieces of the green sheet 14 may be respectively drawn out from the plurality of rolls and stacked one atop another, to form the multiple layers of the green sheet 14.

Further, when magnetic field orientation is carried out to the green sheet 14, to begin with, the green sheet 14 conveyed together with the supporting base 13 is heated to soften. Incidentally, the appropriate temperature and duration for heating the green sheet 14 differ depending on the type or amount of the binder, but can be tentatively set, for instance, at 100 through 250 degrees Celsius and 0.1 through minutes, respectively. However, for the purpose of softening the green sheet 14, the temperature needs to be equal to or higher than the glass transition point or melting point of the binder to be used. Further, the heating method for heating the green sheet 14 may be such a method as heating by a hot plate, or heating using a heat carrier (silicone oil) as a heat source, for instance. Further, magnetic field orientation is performed simultaneously on multiple stacked layers of green sheet 14 by applying magnetic field in an in-plane and machine direction of the multiple layers of green sheet 14 that has been softened by heating. The intensity of the applied magnetic field is 5000 [Oe] through 150000[Oe], or preferably 10000[Oe] through 120000[Oe]. As a result, c-axis (axis of easy magnetization) of each magnet crystal grain included in the multiple stacked layers of green sheet 14 is aligned in one direction. Incidentally, the application direction of the magnetic field may be an in-plane and transverse direction of the green sheet 14.

Incidentally, as to the application of the magnetic field to the green sheet 14, the magnetic field may be applied simultaneously with the heating, or the magnetic field may be applied after the heating and before the green sheet 14 solidifies. Further, the magnetic field may be applied before the green sheet 14 formed by the hot-melt molding solidifies. In such a case, the need of the heating process is eliminated.

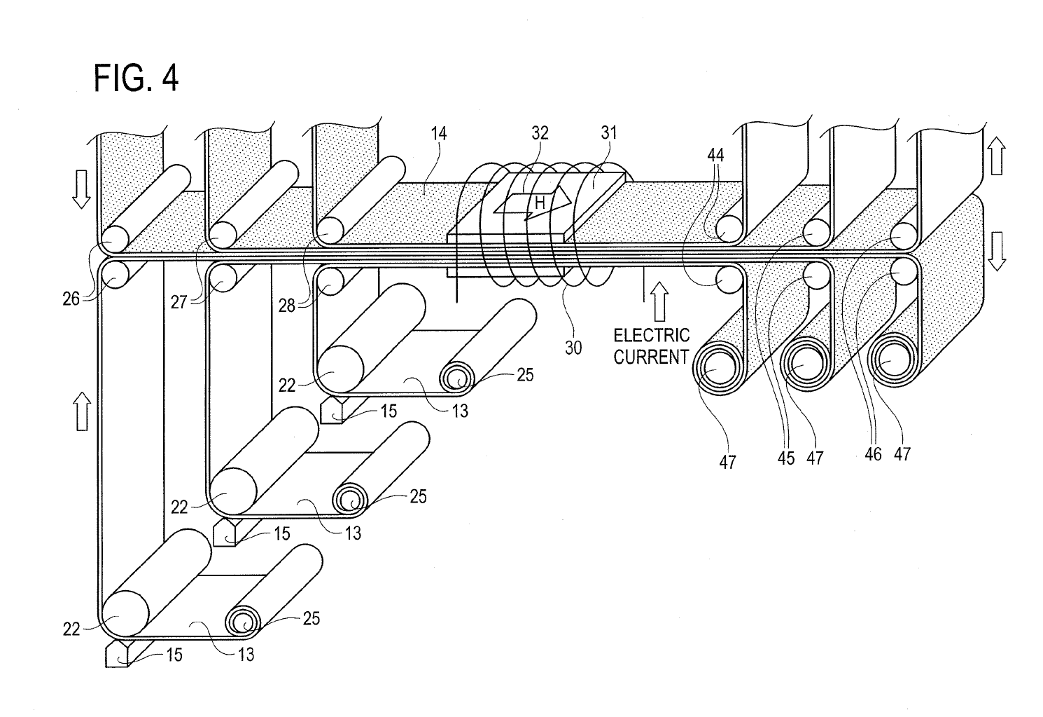

Next, there will be described on a stacking process, a heating process and a magnetic field orientation process of the green sheet 14 in more detail, referring to FIG. 4. FIG. 4 is an explanatory diagram illustrating a stacking process, a heating process and a magnetic field orientation process of the green sheet 14. Referring to FIG. 4, there will be specifically discussed an example where a stacking process, a heating process and a magnetic field orientation process are carried out immediately following the coating on the supporting base 13, and where the heating process and the magnetic field orientation are simultaneously carried out. Incidentally, six layers of green sheet 14 are stacked in this example.

In the example shown in FIG. 4, stacking, heating and magnetic field orientation are performed on the green sheet 14 formed by the above described slot-die system into a long-sheet-like shape and continuously conveyed by a roll. That is, apparatuses for stacking, heating and magnetic field orientation are arranged at the downstream side of a coating apparatus (such as slot-die apparatus) so as to perform stacking, heating and magnetic field orientation subsequent to the coating process.

Specifically, the supporting base 13 is drawn out from each of base rolls (third rolls) 25 arranged in six locations, and using the die 15 or the coating roll 22, six pieces of green sheet 14 are produced. Incidentally, the depiction with regard to the base rolls 25 and the dies 15 arranged on the upper side is omitted in FIG. 4; however, basically the base rolls 25 and the dies 15 are arranged in horizontal symmetry, at three locations on each of the upper and lower sides (at six locations in total).

Thereafter, the produced six pieces of green sheet 14 on the supporting bases 13 are passed between pairs of stacking rolls 26-28 arranged on upper and lower sides so as to be stacked sequentially. Meanwhile, a solenoid 30 is arranged so that the green sheet 14 and the supporting base 13 being conveyed together as stacked in multiple layers pass through the solenoid 30. Further, inside the solenoid 30, hot plates 31 are arranged as a pair on upper and lower sides of the multiple layers of green sheet 14. While heating the multiple layers of the green sheet 14 by the hot plates 31 arranged as a pair on the upper and lower sides, electrical current is applied to the solenoid 30 and magnetic field is generated in an in-plane direction (i.e., direction parallel to a sheet surface of the green sheet 14) as well as a machine direction of the long-sheet-like green sheet 14. Thus, the continuously-conveyed multiple layers of green sheet 14 are softened through heating, and magnetic field (H) is applied to the multiple layers of softened green sheet 14 in the in-plane and machine direction of the green sheet 14 (arrow 32 direction in FIG. 4). Thereby, homogeneous and optimized magnetic field orientation can be performed on the green sheet 14. Especially, application of magnetic field in the in-plane direction thereof can prevent surface of the green sheet 14 from bristling up. Further, the green sheet 14 is subjected to magnetic field orientation under a stacked state in multiple layers, and magnetic field orientation can be performed simultaneously to plural pieces of green sheet in a single process, so that manufacturing efficiency can be drastically enhanced.

Further, the green sheet 14 subjected to the magnetic field orientation is preferably cooled and solidified under the conveyed state, for the sake of higher efficiency at manufacturing processes.

If the above magnetic field orientation is not continuously performed following the coating process, the green sheet 14 formed by the coating process is temporarily rolled around a roll (such as the first roll). A plurality of rolls of the green sheet 14 are prepared, and the green sheet 14 is drawn out from each of the plurality of rolls and continuously conveyed. Plural pieces of green sheet 14 being continuously conveyed undergo the above-described processes of stacking, heating and magnetic field orientation.

Further, when performing the magnetic field orientation in an in-plane and transverse direction of the green sheet 14, the solenoid 30 is replaced with a pair of magnetic coils arranged on the right and left sides of the conveyed green sheet 14. Through energizing both magnetic coils, a magnetic field can be generated in an in-plane and transverse direction of the long sheet-like green sheet 14.

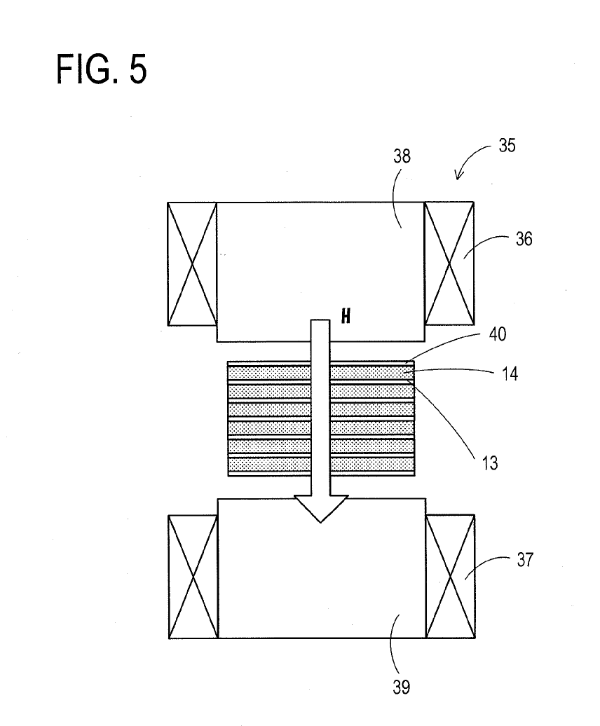

Further, the magnetic field may be oriented in a direction perpendicular to a plane of the green sheet 14. When orienting the magnetic field in the direction perpendicular to a plane of the green sheet 14, there may be used, for instance, a magnetic field application apparatus using pole pieces, etc. Specifically, as illustrated in FIG. 5, a magnetic field application apparatus 35 using pole pieces has two ring-like coil portions 36, 37, and two substantially columnar pole pieces 38, 39. The coil portions 36, 37 are arranged in parallel with each other and coaxially aligned. The pole pieces 38, 39 are arranged inside ring holes of the coil portions 36, 37, respectively. The magnetic field application apparatus 35 is arranged to have a predetermined clearance to a green sheet 14 being conveyed. The coil portions 36, 37 are energized to generate a magnetic field (H) in the direction perpendicular to the plane of the green sheet 14, so that the green sheet 14 is subjected to the magnetic field orientation. However, in the case where the magnetic field is applied in the direction perpendicular to the plane of the green sheet 14, a film 40 is desirably laminated on top of the green sheet 14, on a surface opposite to the surface with the supporting base 13 laminated, as shown in FIG. 5. The surface of the green sheet 14 can thereby be prevented from bristling up.

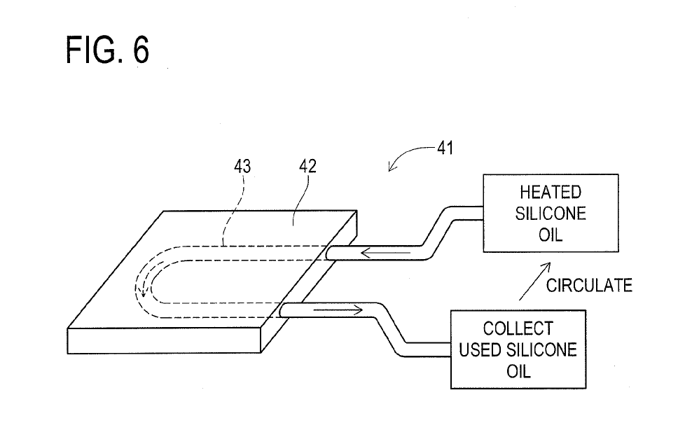

Further, instead of the heating method that uses the above-mentioned hot plates 31, there may be employed a heating method that uses a heat carrier (silicone oil) as a heat source. FIG. 6 is an explanatory diagram illustrating a heating device 41 using a heat carrier.

As shown in FIG. 6, the heating device 41 has a flat plate member 42 as a heater element. The flat plate member 38 has a substantially U-shaped channel 43 formed inside thereof, and silicone oil heated to a predetermined temperature (for instance, 100 through 300 degrees Celsius) is circulated inside the channel 43, as a heat carrier. Then, in place of the hot plates 31 illustrated in FIG. 4, the heating devices 41 are arranged inside the solenoid 30 as a pair on the upper and lower sides of the green sheet 14. As a result, the flat plate members 42 made hot by the heat carrier heats and softens the continuously conveyed green sheet 14. The flat plate member 42 may make direct contact with the green sheet 14, or may have a predetermined clearance to the green sheet 14. Then a magnetic field) is applied to the green sheet 14 in an in-plane and machine direction thereof (direction of arrow 32 in FIG. 4 by the solenoid 30 arranged around the softened green sheet 14, so that the green sheet 14 can be optimally magnetized to have a uniform magnetic field orientation. Unlike a common hot plate 31, there is no internal electric heating cable in such a heating device 41 employing a heat carrier as shown in FIG. 6. Accordingly, even arranged inside a magnetic field, the heating device 41 does not induce a Lorentz force which may cause vibration or breakage of an electric heating cable, and thereby optimal heating of the green sheet 14 can be realized. Further, heat control by electric current may involve a problem that the ON or OFF of the power causes the electric heating cable to vibrate, resulting in fatigue fracture thereof. However, such a problem can be resolved by using a heating device 41 with a heat carrier as a heat source.

Here, the green sheet 14 may be formed using highly fluid liquid material such as slurry, by a conventional slot-die system or a doctor blade system, without employing the hot-melt molding. In such a case, when the green sheet 14 is conveyed into and exposed to the gradients of magnetic field, the magnet powder contained in the green sheet 14 is attracted to a stronger magnetic field. Thereby, liquid distribution of the slurry forming the green sheet 14 becomes imbalanced, resulting in the green sheet 14 with problematic unevenness in thickness. Further, the green sheet 14 may cause deformation or the like therein when stacked in layers. In contrast, in the case where the hot-melt molding is employed for forming the mixture 12 into a green sheet 14 as in the present invention, the viscosity of the mixture 12 reaches several tens of thousands Pa·s in the vicinity of the room temperature. Thus, imbalanced distribution of magnet powder can be prevented at the time the green sheet 14 is exposed to the gradients of magnetic field. Further, the viscosity of the binder therein lowers as the green sheet 14 is conveyed into a homogenous magnetic field and heated, and uniform c-axis orientation becomes attainable merely by the rotary torque in the homogeneous magnetic field. Further, even if the green sheet 14 is stacked in layers, the green sheet 14 will cause no deformation or the like, and accordingly, plural pieces of the green sheet 14 can be optimally stacked.

Further, if the green sheet 14 is formed using highly fluid liquid material such as slurry by a conventional slot-die system or a doctor blade system without employing the hot-melt molding, problematic bubbles are generated at a drying process by evaporation of an organic solvent included in the slurry, when a sheet exceeding 1 mm thick is to be manufactured. Further, if the duration of the drying process is extended in an attempt to suppress bubbles, the magnet powder is caused to precipitate, resulting in imbalanced density distribution of the magnet powder with regard to the gravity direction. This may lead to warpage of the permanent magnet after sintering. Accordingly, in the formation from the slurry, the maximum thickness is virtually restricted, and a green sheet 14 needs to be equal to or thinner than 1 mm thick and be laminated thereafter. However, in such a case, the binder cannot be sufficiently intermingled. This causes delamination at the binder removal process (calcination process), leading to degradation in the orientation in the c-axis (axis of easy magnetization), namely, decrease in residual magnetic flux density (Br). In contrast, in the case where the mixture 12 is formed into a green sheet 14 using hot-melt molding as in the present invention, as the mixture 12 is free from an organic solvent, there is no fear of such bubbles as mentioned in the above, even if a sheet over 1 mm thick is prepared. Further, the binder is well intermingled, and no delamination occurs at the binder removal process.

Further, the heating of the green sheet 14 may be performed on a single layer of green sheet 14 before stacking the green sheet 14 in multiple layers. Further, the number of layers of the green sheet 14 to be stacked is not limited to six layers, but may be more than or less than six, as long as the multiple layers are thin enough to pass through inside the solenoid 30. However, the increase in the number of layers may necessitate longer heating duration.

Thereafter, the plural pieces of the green sheet 14 stacked in multiple layers and subjected to magnetic field orientation are separated into a single layer by separation rolls 44-46, and each single layer currently separated is rolled around a sheet roll (second roll or fourth roll) 47. Incidentally, the depiction of the sheet rolls 47 arranged on the upper side is omitted in FIG. 4. However, the sheet rolls 47 are basically arranged in horizontal symmetry, at three locations on each of the upper and lower sides (six locations in total). As a result, it becomes possible to simultaneously manufacture plural pieces of green sheet 14 in which each c-axis (axis of easy magnetization) of magnet crystal grains is aligned in one direction.

Then, the green sheet 14 thus obtained is die-cut into a desired product shape (for example, the fan-like shape shown in FIG. 1) to produce a formed body 48.

Thereafter, the formed body 48 thus produced is held at a binder-decomposition temperature for several hours (for instance, five hours) in a non-oxidizing atmosphere (specifically in this invention, a hydrogen atmosphere or a mixed gas atmosphere of hydrogen and inert gas) at normal atmospheric pressure or at a pressure higher than or lower than the normal atmospheric pressure (for instance, 1.0 MPa or 1.0 Pa), and a calcination process is performed. The hydrogen feed rate during the calcination is, for instance, 5 L/min, if the calcination is performed in the hydrogen atmosphere. By the calcination process, the binder can be decomposed into monomers through depolymerization reaction, released and removed therefrom. Namely, so-called decarbonization is performed in which carbon content in the formed body 48 is decreased. Furthermore, the calcination process is to be performed under such a condition that carbon content in the formed body 48 is 2000 ppm or lower, or more preferably 1000 ppm or lower. Accordingly, it becomes possible to sinter the permanent magnet 1 densely as a whole in the sintering process that follows, and the decrease in the residual magnetic flux density or in the coercive force can be prevented. Furthermore, if the pressure higher than the atmospheric pressure is employed with regard to a pressurization condition at the calcination process, the pressure is preferably 15 MPa or lower.

The temperature for decomposing the binder is determined based on the analysis of the binder decomposition products and decomposition residues. In particular, the temperature range to be selected is such that, when the binder decomposition products are trapped, no decomposition products except monomers are detected, and when the residues are analyzed, no products due to the side reaction of remnant binder components are detected. The temperature differs depending on the type of binder, but may be set at 200 through 900 degrees Celsius, or more preferably 400 through 600 degrees Celsius (for instance, 600 degrees Celsius).

Further, in the case where the magnet raw material is milled in an organic solvent by wet-milling, the calcination process is performed at a decomposition temperature of the organic compound composing the organic solvent as well as the binder decomposition temperature. Accordingly, it is also made possible to remove the residual organic solvent. The decomposition temperature for an organic compound is determined based on the type of organic solvent to be used, but the above binder decomposition temperature is basically sufficient to thermally decompose the organic compound.

Further, a dehydrogenation process may be carried out through successively holding, in a vacuum atmosphere, the formed body 48 calcined at the calcination process. In the dehydrogenation process, NdH₃ (having high reactivity level) in the formed body 48 created at the calcination process is gradually changed, from NdH₃ (having high reactivity level) to NdH₂ (having low reactivity level). As a result, the reactivity level is decreased with respect to the formed body 48 activated by the calcination process. Accordingly, if the formed body 48 calcined at the calcination process is later moved into the atmosphere, Nd therein is prevented from combining with oxygen, and the decrease in the residual magnetic flux density and coercive force can also be prevented. Further, there can be expected an effect of putting the crystal structure of the magnet from those with NdH₂ or the like back to the structure of Nd₂Fe₁₄B.

Thereafter, a sintering process is performed in which the formed body 48 calcined in the calcination process is sintered. Incidentally, a sintering method of the formed body 48 may include, besides generally-used vacuum sintering, the pressure sintering where the pressurized formed body 48 is sintered. For instance, when the vacuum sintering is performed, the temperature is raised to the sintering temperature of approximately 800 through 1080 degrees Celsius in a given rate of temperature increase and held for approximately 0.1 through 2.0 hours. During this period, vacuum sintering is performed, and the degree of vacuum is preferably equal to or smaller than 5 Pa, or preferably equal to or smaller than 10⁻² Pa. The formed body 48 is then cooled down, and again undergoes a heat treatment in 300 through 1000 degrees Celsius for two hours. As a result of the sintering, the permanent magnet 1 is manufactured.

Meanwhile, the pressure sintering includes, for instance, hot pressing, hot isostatic pressing (HIP), high pressure synthesis, gas pressure sintering, spark plasma sintering (SPS) and the like. However, it is preferable to adopt the spark plasma sintering which is uniaxial pressure sintering in which pressure is uniaxially applied and also in which sintering is preformed by electric current sintering so as to prevent grain growth of the magnet particles during the sintering and also to prevent warpage formed in the sintered magnets. When the SPS is performed, it is preferable that the pressure value is set, for instance, at 0.01 MPa through 100 MPa, and the temperature is raised to approximately 940 degrees Celsius at a rate of 10 degrees C./min. in a vacuum atmosphere of several Pa or lower, and held for five minutes. The formed body 48 is then cooled down, and again undergoes a heat treatment in 300 through 1000 degrees Celsius for two hours. As a result of the sintering, the permanent magnet 1 is manufactured.

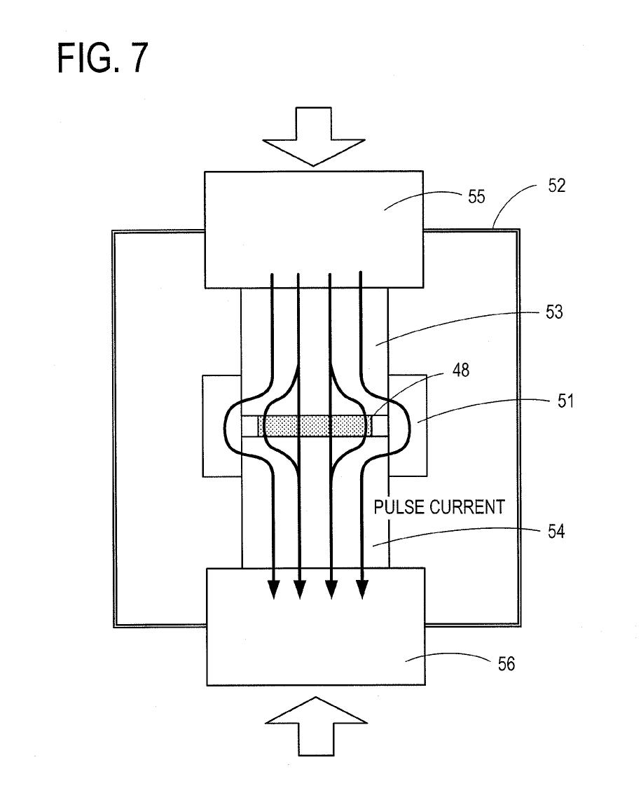

Here will be given a detailed description of the pressure sintering process of a formed body 48 using the SPS method, referring to FIG. 7. FIG. 7 is a schematic diagram depicting the pressure sintering process of the formed body 48 using the SPS method.

When performing the spark plasma sintering as illustrated in FIG. 7, first, the formed body 48 is put in a graphite sintering die 51. Incidentally, the above calcination process may also be performed under this state where the formed body 48 is put in the sintering die 51. Then, the formed body 48 put in the sintering die 51 is held in a vacuum chamber 52, and an upper punch 53 and a lower punch 54 also made of graphite are set thereat. After that, using an upper punch electrode 55 coupled to the upper punch 53 and a lower punch electrode 56 coupled to the lower punch 54, pulsed DC voltage/current being low voltage and high current is applied. At the same time, a load is applied to the upper punch 53 and the lower punch from upper and lower directions using a pressurizing mechanism (not shown). As a result, the formed body 48 put inside the sintering die 51 is sintered while being pressurized. Further, the spark plasma sintering is preferably executed to a plurality of formed bodies (for instance, ten formed bodies) 48 simultaneously, so that the productivity may be improved. Incidentally, at the simultaneous spark plasma sintering to the plurality of formed bodies 48, the plurality of formed bodies 48 may be put in one sintering space, or may be respectively arranged in different sintering spaces. Incidentally, in the case that the plurality of formed bodies 48 are respectively arranged in different sintering spaces, an SPS apparatus provided with a plurality of sintering spaces is used to execute sintering. There, the upper punch 53 and the lower punch 54 for pressing the formed bodies 48 are configured to be integrally used for the plurality of sintering spaces (so that the pressure can be applied simultaneously by the upper punch 53 and the lower punch 54 which are integrally operated).

Incidentally, the detailed sintering condition is as follows:
Pressure value: 1 MPa
Sintering temperature: raised by 10 deg. C. per min. up to 940 deg. C. and held for 5 min.
Atmosphere: vacuum atmosphere of several Pa or lower.

### EMBODIMENT

Embodiments according to the present invention will now be described referring to comparative examples for comparison.

### Embodiment 1

In the embodiment, there is used an Nd—Fe—B-based magnet, and alloy composition thereof is Nd/Fe/B=32.7/65.96/1.34 in wt %. Polyisobutylene (PIB) has been used as binder. A green sheet is obtained through coating the base with the heated and molten mixture by a slot-die system. Further, six pieces of the obtained green sheet are stacked, and under the state stacked in six layers, heated for five minutes with hot plates whose temperature is raised to 200 degrees Celsius, and further, a 12 T magnetic field is applied to the green sheet in the in-plane and machine direction for magnetic field orientation. After the magnetic field orientation, the green sheet has been punched out into a desired shape and calcined in hydrogen atmosphere, and thereafter, the green sheet has been sintered by SPS method (at pressure value of 1 MPa, raising sintering temperature by 10 degrees Celsius per minute up to 940 degrees Celsius and holding it for 5 minutes). Other processes are the same as the processes in [Method for Manufacturing Permanent Magnet] mentioned above.

### Embodiment 2

A styrene-isoprene block copolymer (SIS) obtained by copolymerization of styrene and isoprene has been used as binder to be mixed. Other conditions are the same as the conditions in embodiment 1.

### Embodiment 3

Octacosane, a kind of long-chain alkane, has been used as binder to be mixed. Other conditions are the same as the conditions in embodiment 1.

### Comparative Example 1

A green sheet without magnetic field orientation has been sintered to manufacture a permanent magnet. Other conditions are the same as the conditions in the embodiments.

### Comparative Example 2

Polybutylmethacrylate has been used as binder to be mixed. Other conditions are the same as the conditions in embodiment 1.

### Comparative Example 3

A permanent magnet has been manufactured without the calcination process. Other conditions are the same as the conditions in embodiment 1.

### Comparison of Embodiments with Comparative Examples

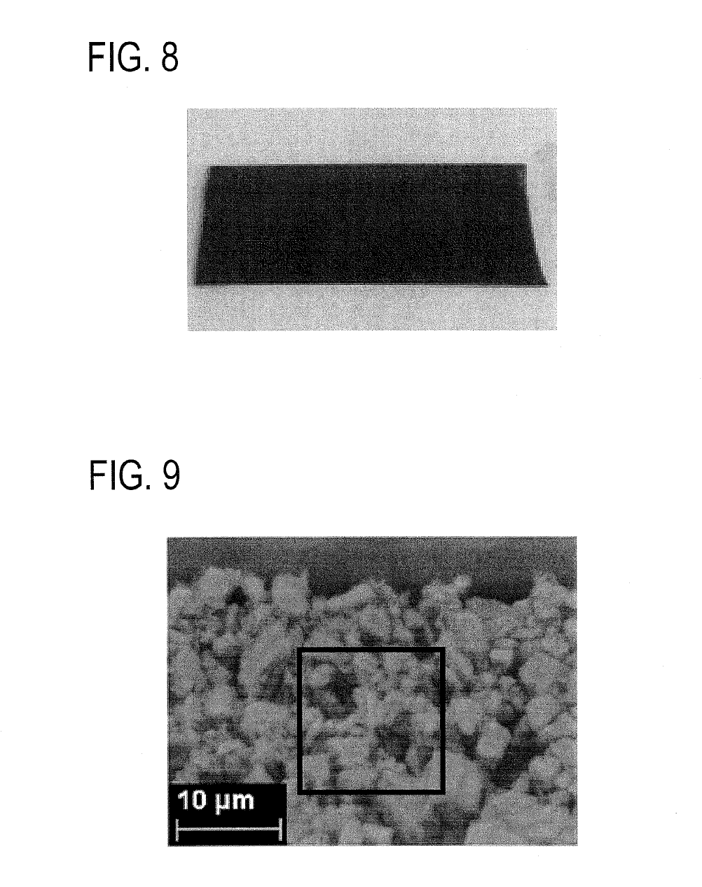

Here, FIG. 8 depicts an external appearance of a green sheet of the embodiment 1 after magnetic field orientation. As shown in FIG. 8, no bristling-up can be observed with respect to the surface of a green sheet after magnetic field orientation of the embodiment 1. Accordingly, the sintered permanent magnet of the embodiment 1, where the green sheet is punched out to form a desired shape as shown in FIG. 8, requires no adjustment process so that the manufacturing process can be simplified. The permanent magnet of the embodiment can thereby be manufactured with dimensional accuracy.

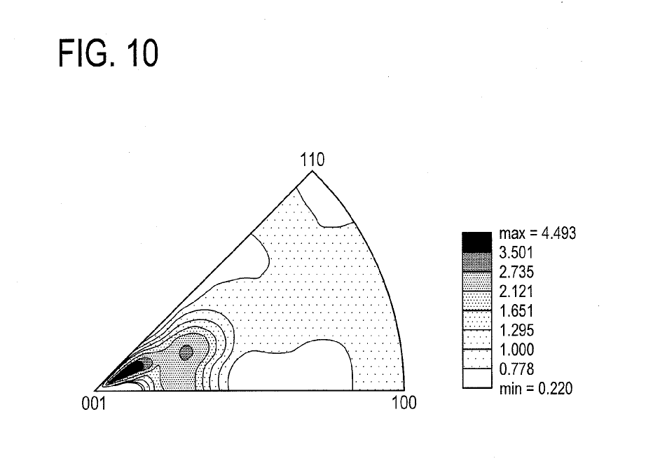

Meanwhile, FIG. 9 is an SEM image of a green sheet of the embodiment 1 taken after magnetic field orientation in a direction perpendicular to a c-axis (in other words, in an in-plane and machine direction of the green sheet in which direction a magnetic field is applied). FIG. 10 is the inverse pole figure showing the crystal orientation distribution analyzed through an electron backscatter diffraction pattern analysis with respect to an area surrounded by a frame in FIG. 9. Referring to FIG. 10, there can be found that the magnetic field orientation of the magnet particles is rather oriented in a <001> direction than other directions, in the green sheet of the embodiment. That is, the magnetic field orientation is optimized in the embodiment 1 even if the magnetic field orientation is performed to the green sheet stacked in multiple layers, so that the magnetic properties of the permanent magnet can be improved. Incidentally, sintering of the green sheet thereafter can further help improve the direction of the magnetic field orientation of the magnet particles. Meanwhile, no such orientation in the <001> direction as in the embodiment can be found in comparative example 1 where no magnetic field orientation is performed.

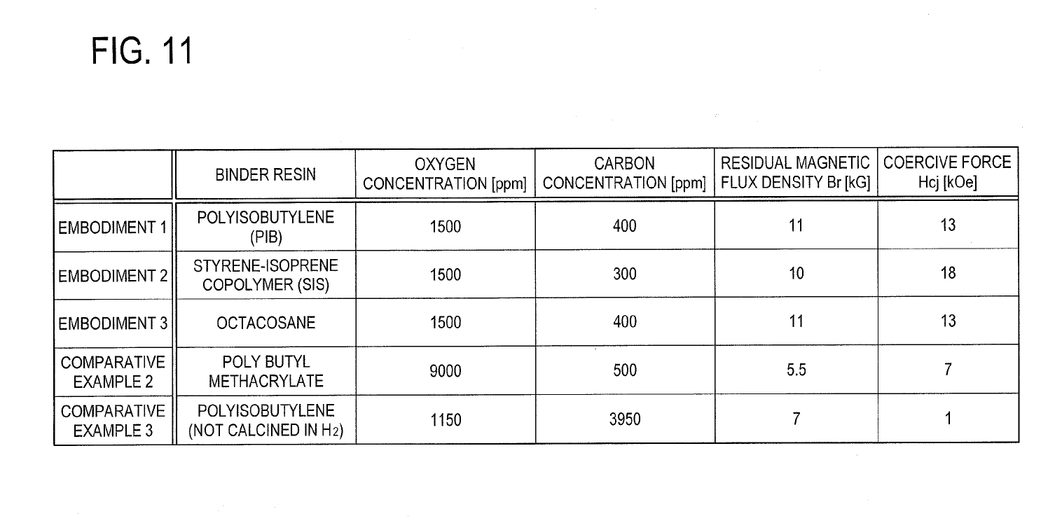

There have been measured oxygen concentration [ppm] and carbon concentration [ppm] remaining in respective magnets of embodiments 1 through 3 and comparative examples 2 and 3. Further, there have been measured residual magnetic flux density [kG] and coercive force [kOe] regarding the embodiments 1 through 3 and the comparative examples 2 and 3. FIG. 11 shows measurement results regarding respective embodiments and comparative examples.

It is apparent from FIG. 11 that the oxygen content remaining in the magnet can be reduced significantly in cases of using binder having no oxygen atoms, such as polyisobutylene (PIB), a styrene-isoprene copolymer (SIS) and octacosane, in comparison with a case of using binder having oxygen atoms such as polybutylmethacrylate. Specifically, the oxygen content remaining in the sintered magnet can be reduced to 5000 ppm or lower, more specifically, 2000 ppm or lower. Consequently, such low oxygen content can prevent Nd from binding to oxygen to form a Nd oxide and also prevent alpha iron from separating out. Accordingly, as shown in FIG. 11, cases of using polyisobutylene and the like as binder also show higher values of residual magnetic flux density or coercive force.

Further, as shown in FIG. 11, it is apparent that carbon content contained in the magnet can be reduced significantly in a case of performing a calcination process, in comparison with a case of not performing a calcination process. Further, owing to the calcination process, carbon content remaining in the sintered magnet is reduced to 2000 ppm or lower, more specifically, 1000 ppm or lower. Consequently, the entirety of the magnet can be sintered densely without making a gap between a main phase and a grain boundary phase. Further, decrease in the residual magnetic flux density can be prevented.

As described in the above, according to the permanent magnet 1 and the method for manufacturing the permanent magnet 1 directed to the embodiments, magnet material is milled into magnet powder. Next, the magnet powder and a binder are mixed to obtain a mixture 12. Next, the thus prepared mixture 12 is formed into long-sheet-like shape on a supporting base 13 through hot-melt molding so as to obtain a green sheet 14. Thereafter, the thus obtained green sheet 14 is heated and softened, and the heated green sheet 14 is exposed to magnetic field under a state stacked in multiple layers for magnetic field orientation. Further, by sintering the green sheet 14 having been subjected to the magnetic field orientation, the permanent magnet 1 is manufactured. The green sheet 14 uniformly contracts at sintering and thus deformations such as warpage and depressions do not occur there. Further, uneven pressure cannot occur at the pressurizing process, which eliminates the need of conventional adjustment process after sintering and simplifies the manufacturing process. Thereby, a permanent magnet can be manufactured with dimensional accuracy. Further, even if such permanent magnets are made thin in the course of manufacturing, increase in the number of manufacturing processes can be avoided without lowering a material yield. Further, while the formed green sheet 14 is heated, magnetic field is applied to the heated green sheet 14 for magnetic field orientation. Therefore, optimized magnetic field orientation can be performed to the green sheet 14 even after the green sheet 14 is formed into a desired shape, and the magnetic properties of the permanent magnet can be improved. Further, imbalanced fluid distribution, namely, problematic unevenness in thickness of the green sheet 14 can be prevented, at magnetic field orientation. Further, viscosity of the binder turns low by being conveyed into and heated in the homogeneous magnetic field. Accordingly, the torque exerted by the homogeneous magnetic field is sufficient for achieving uniform c-axis orientation. Further, even when producing a green sheet 14 with a thickness exceeding 1 mm, no air bubbles are generated in the green sheet 14, and the binder is well intermingled so that the possibility of delamination can be eliminated in the binder removal process (calcination process).

Further, the green sheet 14 is subjected to magnetic field orientation as stacked in multiple layers. Thus, plural pieces of green sheet 14 can be simultaneously oriented in c-axis direction in a single process, so that manufacturing efficiency can be drastically improved. Further, in comparison with the green sheet produced from slurry, the green sheet 14 produced by hot-melt molding is less likely to cause deformation or the like even when stacked, and a plurality of green sheets 14 can be stacked optimally.

Further, heating is also be performed to the green sheet 14 stacked in multiple layers, and the plural pieces of green sheet 14 can be simultaneously heated in a single process, so that manufacturing efficiency can be drastically enhanced.

Further, the green sheet 14 is formed by coating the continuously-conveyed supporting base 13 with the mixture 12, and the green sheet 14 being continuously conveyed together with the supporting base 13 is heated and exposed to a magnetic field for magnetic field orientation. Accordingly, a series of processes can be performed successively, from forming the green sheet to heating and orienting a magnetic field. Thereby, the manufacturing process can be simplified and productivity can be improved.

Further, if the magnetic field orientation is not performed immediately following the coating process, the green sheet obtained by the hot-melt molding is temporarily rolled around a first roll. Thereafter, the green sheet is drawn out from each of a plurality of first rolls. Plural pieces of green sheet are stacked, then magnetic field is applied to the plural pieces of green sheet stacked in multiple layers for magnetic field orientation, and the stacked plural pieces of green sheet subjected to magnetic field orientation are separated into single layers and rolled around a plurality of sheet rolls (second rolls) 47, respectively. According to the configuration, the processes from the stacking of the green sheet to the heating and magnetic field orientation can be successively performed, so that manufacturing processes can be simplified and the production efficiency can be improved.

Further, if the above magnetic field orientation is performed immediately following the coating process, first, plural pieces of green sheet are obtained through drawing out a plurality of bases from a plurality of base rolls (third rolls) and the plurality of bases are coated with the mixture. Then, the obtained plural pieces of green sheet are stacked in layers, magnetic field is applied to the stacked multiple layers of green sheet for magnetic field orientation and the stacked multiple layers of green sheet subjected to the magnetic field orientation are separated into single individual pieces to be rolled around a plurality of sheet rolls (fourth rolls) 47, respectively. According to the configuration, the processes from the obtaining the green sheet to heating and magnetic field orientation can be performed by successive processes, so that manufacturing processes can be simplified and the production efficiency can be improved.

Further, the green sheet 14 conveyed together with the base is made to pass through a solenoid 30 charged with electric current so as to be exposed to a magnetic field. Accordingly, the magnetic field can be uniformly applied to the green sheet 14 and homogeneous and optimized magnetic field orientation can be performed.

Further, in the magnetic field orientation process, the green sheet 14 is heated up to a temperature equal to or above the glass transition point or the melting point of the binder to soften. The magnetic field orientation is performed to the softened green sheet 14, enabling optimized magnetic field orientation.

Further, before the step of sintering the green sheet 14, the binder is decomposed and removed from the green sheet 14 by holding the green sheet 14 for a predetermined length of time at binder decomposition temperature in a non-oxidizing atmosphere, so that the carbon content in the magnet can be reduced previously. Thereby, the entirety of the magnet can be sintered densely without making a gap between a main phase and a grain boundary phase in the sintered magnet and decline of the coercive force can be avoided. Further, alpha iron does not separate out in large amounts in the main phase of the sintered magnet and serious deterioration of magnetic properties can be avoided.

Further, in the step of calcination, the green sheet 14 with the binder included therein is held in a hydrogen atmosphere or a mixed gas atmosphere of hydrogen and inert gas for a predetermined length of time at temperature range of 200 through 900 degrees Celsius, or more preferably, at 400 through 600 degrees Celsius. Thereby, carbon content in the magnet can be reduced more reliably.

Further, the oxygen content remaining in the sintered magnet can be reduced by using, as a binder, a long-chain hydrocarbon or a thermoplastic resin made of a polymer or a copolymer consisting of monomers containing no oxygen atoms. Further, through heating, the green sheet 14 once formed can be softened so that magnetic field orientation can be optimally performed.

It is to be understood that the present invention is not limited to the embodiments described above, but may be variously improved and modified without departing from the scope of the present invention.

Further, milling condition for magnet powder, mixing condition, stacking condition, magnetic field orientation condition, calcination condition, sintering condition, etc. are not restricted to conditions described in the embodiments. For instance, in the above described embodiments, magnet material is dry-milled by using a jet mill. Alternatively, magnet material may be wet-milled by using a bead mill. In the above embodiments, the green sheet is formed in accordance with a slot-die system. However, a green sheet may be formed in accordance with other system or molding (e.g., calender roll system, comma coating system, extruding system, injection molding, die casting, doctor blade system, etc.), as long as it is the system capable of forming a green sheet on a base, using the fluid-state mixture, with a high degree of accuracy.

Further, in the above embodiments, heating and magnetic field orientation of the green sheet 14 are simultaneously performed; however, the magnetic field orientation may be performed after heating and before solidifying the green sheet 14. Further, if the magnetic field orientation is performed before the formed green sheet 14 solidifies (that is, performed on the green sheet 14 in a softened state without the heating process), the heating process may be omitted. The heating may be performed before stacking up the pieces of green sheet 14. The stacking-up and magnetic field orientation may be performed afterwards.

Although resin, long-chain hydrocarbon, and fatty acid methyl ester are mentioned as examples of binder in the embodiments, other materials may be used.

Further, in the above embodiments, a slot-die coating process, a heating process and a magnetic field orientation process are performed consecutively. However, these processes need not be consecutive. Alternatively, the processes can be divided into two parts: the first part up to the slot-die coating process and the second part from the heating process and the processes that follow, and each of the two parts is performed consecutively. In such a case, the formed green sheet 14 may be cut at a predetermined length and stacked in layers, and plural pieces of green sheet 14 in a stationary state may be heated and exposed to the magnetic field for the magnetic field orientation.

Description of the present invention has been given by taking the example of the Nd—Fe—B-based magnet. However, other kinds of magnets may be used (for instance, cobalt magnet, alnico magnet, ferrite magnet, etc.). Further, in the alloy composition of the magnet in the embodiments of the present invention, the proportion of the Nd component is larger than that in the stoichiometric composition. However, the proportion of the Nd component may be the same as in the stoichiometric composition. Further, the present invention can be applied not only to anisotropic magnet but also to isotropic magnet. In the case of the isotropic magnet, the magnetic field orientation process for the green sheet 14 can be omitted.

### DESCRIPTION OF REFERENCE NUMERALS AND SIGNS

1 permanent magnet
11 jet mill
12 mixture
13 supporting base
14 green sheet
15 slot die
25 base roll
26-28 stacking roll
30 solenoid
31 hot plate
44-46 separation roll
47 sheet roll
48 formed body

1. A manufacturing method of a rare-earth permanent magnet comprising steps of:
milling magnet material into magnet powder;
preparing a mixture of the magnet powder and a binder;
obtaining a green sheet through thermally melting and forming the mixture into a sheet-like shape;
heating the green sheet and simultaneously/subsequently applying a magnetic field to multiple layers of the heated green sheet, for magnetic field orientation; and
sintering the green sheet subjected to the magnetic field orientation.

2. The manufacturing method of a rare-earth permanent magnet according to claim 1, wherein, in the step of heating the green sheet and simultaneously/subsequently applying a magnetic field, multiple layers of the green sheet are heated.

3. The manufacturing method of a rare-earth permanent magnet according to claim 1, wherein,
in the step of obtaining a green sheet, a base that is continuously conveyed is coated with the mixture, so as to form the green sheet on the base, and
in the step of heating the green sheet and simultaneously/subsequently applying a magnetic field, the green sheet is continuously conveyed together with the base.

4. The manufacturing method of a rare-earth permanent magnet according to claim 3 further comprising steps of:
after the step of obtaining a green sheet, rolling up the green sheet around each of a plurality of first rolls, and drawing out the green sheet from each of the plurality of first rolls, and stacking up the drawn-out green sheet to form the multiple layers of the green sheet, so that the magnetic field is simultaneously applied to the multiple layers of the green sheet; and
separating the multiple layers of the green sheet subjected to the magnetic field orientation back into each single layer of the green sheet, and rolling up the single layer of the green sheet around each of a plurality of second rolls.

5. The manufacturing method of a rare-earth permanent magnet according to claim 3, wherein,
in the step of obtaining a green sheet, each of a plurality of bases drawn out from a plurality of third rolls is coated with the mixture, so as to form the green sheet on each of the plurality of bases, and
in the step of heating the green sheet and simultaneously/subsequently applying a magnetic field, the green sheet on each of the plurality of bases is stacked to form multiple layers of the green sheet and the magnetic field is simultaneously applied to the multiple layers of the green sheet, and wherein
the manufacturing method further comprises a step of: separating the multiple layers of the green sheet subjected to the magnetic field orientation back into each single layer of the green sheet, and rolling up the single layer of the green sheet around each of a plurality of fourth rolls.

6. The manufacturing method of a rare-earth permanent magnet according to claim 3, wherein, in the step of heating the green sheet and simultaneously/subsequently applying a magnetic field, the green sheet conveyed together with the base is made to pass through a solenoid charged with electric current.

7. The manufacturing method of a rare-earth permanent magnet according to claim 1, wherein,
the binder is any one of thermoplastic resin, a long-chain hydrocarbon and a fatty acid methyl ester, or any mixture thereof, and
in the step of heating the green sheet and simultaneously/subsequently applying a magnetic field, the green sheet is heated to a temperature equal to or higher than a glass-transition point or melting point of the binder.

8. The manufacturing method of a rare-earth permanent magnet according to claim 1, wherein, before the step of sintering the green sheet, the binder is decomposed and removed from the green sheet by holding the green sheet for a predetermined length of time at binder decomposition temperature in a non-oxidizing atmosphere.

9. A rare-earth permanent magnet manufactured through steps of:
milling magnet material into magnet powder;
preparing a mixture of the magnet powder and a binder;
obtaining a green sheet through thermally melting and forming the mixture into a sheet-like shape;
heating the green sheet and simultaneously/subsequently applying a magnetic field to multiple layers of the heated green sheet, for magnetic field orientation; and
sintering the green sheet subjected to the magnetic field orientation.

10. The manufacturing method of a rare-earth permanent magnet according to claim 2, wherein,
in the step of obtaining a green sheet, a base that is continuously conveyed is coated with the mixture, so as to form the green sheet on the base, and
in the step of heating the green sheet and simultaneously/subsequently applying a magnetic field, the green sheet is continuously conveyed together with the base.
